(19) United States
(12) Patent Application Publication
(10) Pub. No.: US 2017/0171513 A1
(43) Pub. Date: Jun. 15, 2017

(54) REMOTE CONFERENCE SYSTEM, COMMUNICATION TERMINAL, AND PROGRAM

(71) Applicant: Shigeru NAKAMURA, Kanagawa (JP)

(72) Inventor: Shigeru NAKAMURA, Kanagawa (JP)

(21) Appl. No.: 15/325,829

(22) PCT Filed: Jun. 25, 2015
(86) PCT No.: PCT/JP2015/069082

§ 371 Date: Jan. 12, 2017

(30) Foreign Application Priority Data
Jul. 25, 2014 (JP) 2014-152135

(51) Int. Cl. H04N 7/15

(52) U.S. Cl. CPC H04N 7/152

(57) ABSTRACT

A remote conference system includes a plurality of communication terminals having respective imaging units and connected to each other via a network. Further, one of the communication terminals includes a transmission unit transmitting alternative data that differ from imaged data that are captured by the imaging unit to the other communication terminals when a function of the imaging unit is set to be disabled, and a display control unit displaying a screen including the alternative data transmitted from one of the other communication terminals on a display device.

### TECHNICAL FIELD

The present invention relates to a remote conference system, which makes it possible to conduct a conference between remote locations via a network, a communication terminal used in the remote conference system, and a program which is to be executed by the communication terminal.

### BACKGROUND ART

Recently, a remote conference system has become more and more popular which conducts a conference by a video conference between remote locations via a communication network such as the Internet.

Such a remote conference system includes a communication terminal, which is installed (provided) in a conference room of one participant, and another communication terminal of the other party (end) for another participant which is installed in another conference room of the other participant. The communication terminal captures an image of the conference room including the participant, receives voices of pronunciations, etc., converts the image and the voices into image data and voice data, respectively, as digital data, and transmits the digital data to the other communication terminal of the other party. The communication terminal of the other party receives and displays the image data on a display of the communication terminal. The communication terminal of the other party further receives the voice data and outputs voice of the voice data from a speaker of the communication terminal. By doing this, a conference similar to the actual conference can be realized

In such a remote conference system, as preparation for a case when, for example, a participant does not like to send an image to the other party, there is a known technique in which a camera function is disabled so that no image can be transmitted to the communication terminal of the other party.

### SUMMARY OF THE INVENTION

### Problems to be Solved by the Invention

In a conventional remote conference system, when the camera function of a camera is disabled, the camera stops transmission of the images captured by the camera. As a result, in a conference screen of communication terminal of the other party, only voice data can be transmitted and received without displaying any image from the camera whose camera function has been disabled.

Due to this, especially in a case where there are many locations that participate in a conference, it becomes difficult to determine whether a person of the other party does not participate in the meeting or the camera function is set to disabled. That it, it is difficult to know who are the participants.

The present invention is made in light of the above circumstances, and may make it easier to know who are the participants.

### Means for Solving the Problems

According to an aspect of the present invention, a remote conference system includes a plurality of communication terminals having respective imaging units and connected to each other via a network. Further, one of the communication terminals includes a transmission unit transmitting alternative data that differ from imaged data that are captured by the imaging unit to the other communication terminals when a function of the imaging unit is set to be disabled, and a display control unit displaying a screen including the alternative data transmitted from one of the other communication terminals on a display device.

### Effects of the Present Invention

According to an aspect of the present invention, it becomes easier to know who are the participants of the conference.

### BRIEF DESCRIPTION OF THE DRAWINGS

FIG. 1 is a view schematically illustrating a configuration of a remote conference system according to an embodiment;

FIG. 2 is an external view of a communication terminal according to an embodiment;

FIG. 3 illustrates a hardware configuration of the communication terminal according to an embodiment;

FIG. 4 illustrates an example hardware configuration of a relay apparatus used in the remote conference system according to an embodiment;

FIG. 5 is a functional block diagram of the communication terminal according to an embodiment;

FIG. 6 illustrates an example of a transmission management table stored in the communication terminal;

FIG. 7 illustrates a relationship between location information and video data or display data allocated to areas;

FIGS. 8A and 8B illustrate examples how a display is divided and the areas generated by the division;

FIG. 9 is a functional block diagram of the relay apparatus;

FIG. 10 illustrates an example of a reception management table stored by the relay apparatus;

FIG. 11 illustrates another example of the reception management table stored by the relay apparatus;

FIG. 12 is a flowchart of a process performed by the communication terminal when a camera function is disabled;

FIG. 13A is a view illustrating a case when the communication terminal does not receive alternative data;

FIG. 13B is a view illustrating a case when the communication terminal receives the alternative data;

FIG. 14 is a view of a comparative example illustrating an effect according to an embodiment; and

FIG. 15 illustrating an example of a list of participants of a conference.

### BEST MODE FOR CARRYING OUT THE INVENTION

In a remote conference system according to an embodiment, when a camera function of a communication terminal is set to be disabled, in place of the imaging data captured so far by a camera, previously prepared image data (alternative data) are transmitted to the communication terminal of the other party. In the communication terminal of the other party, the alternative data are displayed in the area where the imaging data were displayed. Therefore, it becomes easier to determine that the person of the other party who has set the camera function to be disabled continuously participates in the conference.

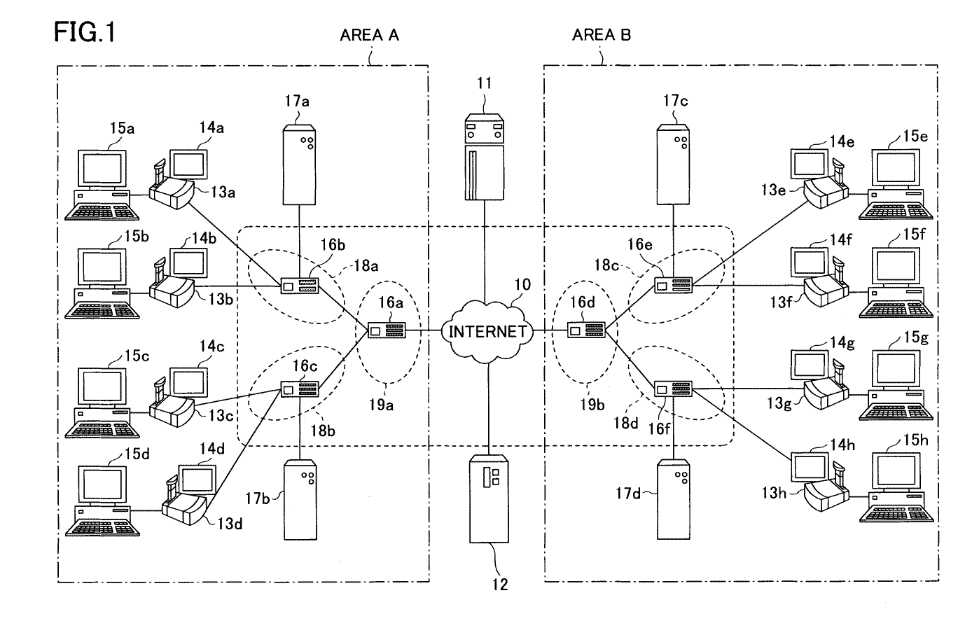

FIG. 1 schematically illustrates an example configuration of the remote conference system according this embodiment. The remote conference system herein refers to a system in which participants, who are geographically separated from each other and participate in a conference, display and see images of the participants and the facial expressions thereof, conference documents, etc., so that the participants can communicate with each other. In this regard, any system by which communication can be performed may be included in the remote conference system. The remote conference system may include, for example, a television or video conference system, a television telephone system, etc.

In the remote conference system of FIG. 1, a conference can be held between two areas “A” and “B”, which are geographically far separated from each other. The area “A” is, for example, Japan and the area “B” is, for example, the United States of America (USA). Here, in this example, the number of areas is two (areas “A” and “B”). However, note that the number of the areas may be more than two.

In the remote conference system, the communication terminals in the areas “A” and “B” are connected to each other via the Internet 10 so as to communicate with each other. The communication is held by using an appropriate communication protocol such as Transmission Control Protocol (TCP)/Internet Protocol (IP), etc.

The remote conference system of FIG. 1 includes a management server 11, a program providing server 12, communication terminals 13a through 13h, and displays 14a through 14h connected to the corresponding communication terminals 13a through 13h. The remote conference system further includes external input devices 15a through 15h connected to the corresponding communication terminals 13a through 13h. The remote conference system further includes routers 16a through 16f, which relay between the Internet 10 and the communication terminals 13a through 13h, and relay apparatuses 17a through 17d which are connected to the routers 16b, 16c, 16e, and 16f, respectively.

In area “A”, the communication terminals 13a through 13d, the displays 14a through 14d, the external input devices 15a through 15d, the routers 16a through 16c to be connected, and the relay apparatuses 17a and 17b are installed. The communication terminals 13a and 13b, the router 16b, and the relay apparatus 17a are connected to each other via a Local Area Network (LAN) 18a so as to communicate with each other. The communication terminals 13c and 13d, the router 16c, and the relay apparatus 17b are connected to each other via a LAN 18b so as to communicate with each other. The LANs 18a and 18b are connected to the Internet 10 via a dedicated line 19a including the router 16a.

In area “B”, the communication terminals 13e through 13h, the displays 14e through 14h, the external input devices 15e through 15h, the routers 16d through 16f to be connected, and the relay apparatuses 17c and 17d are installed. The communication terminals 13e and 13f, the router 16e, and the relay apparatus 17c are connected to each other via a LAN 18c so as to communicate with each other. The communication terminals 13g and 13h, the router 16f, and the relay apparatus 17d are connected to each other via a LAN 18d so as to communicate with each other. The LANs 18c and 18d are connected to the Internet 10 via a dedicated line 19b including the router 16d.

In this embodiment, a communication network is established by the Internet 10, the LANs 18a through 18d, and the dedicated lines 19a and 19b. For example, in the area “A”, the LAN 18a is installed in Tokyo office and the LAN 18b is installed in Osaka office. Further, in the area “B”, the LAN 18c is installed in New York office and the LAN 18d is installed in Washington D.C. office.

In the following, to represent any of the communication terminals, the displays, the external input devices, the routers, the relay apparatuses, the LANs, the dedicated lines, the terms “communication terminal(s) 13”, “display(s) 14”, “external input device(s) 15”, “router(s) 16”, “relay apparatus(es) 17”, “LAN(s) 18”, and “dedicated line(s) 19”, respectively, are used.

The program providing server 12 includes a storage device to store programs to be provided to the communication terminals 13a through 13h, the management server 11, and the relay apparatuses 17a through 17d. The program providing server 12 reads a program which corresponds to a request from the communication terminals 13a through 13h, the management server 11, and the relay apparatuses 17a through 17d, and transmits the program. The program is installed in the communication terminals 13a through 13h, the management server 11, and the relay apparatuses 17a through 17d and realizes various functions described below.

The management server 11 receives the program from the program providing server 12 and installs the program to manage the communications between the two areas “A” and “B”. The management server 11 stores various tables and uses the various tables to manage the communications. As one example of the various tables, there is a terminal authentication management table. As an example, the terminal authentication management table refers to a table that manages terminal identifiers (terminal IDs), which are allocated to all the communication terminals 13, in association with respective passwords. Those terminal IDs and passwords are used for authentication in a process to log into a remote conference system to hold a remote conference.

As other tables, there are, for example, a communication terminal management table, a relay apparatus management table, a destination list management table, a session management table, etc. The communication terminal management table refers to a table that manages the terminal IDs of the communication terminals 13 in association with operating states of the communication terminals 13, date and time when log-in request information, such as the terminal IDs and the passwords, transmitted from the communication terminals 13, the IP addresses of the communication terminals 13, etc. The operating states include, for example, “on-line”, “off-line”, “in failure”, etc.

The relay apparatus management table refers to a table that manages device identifiers (device IDs), which are allocated to the relay apparatuses 17 in association with the operating states of the relay apparatuses 17, date and time when state information of the relay apparatuses 17 is received, the IP addresses of the relay apparatuses 17, the maximum data transmission rate, etc. The destination list management table refers to a table that manages the terminal ID of the communication terminal 13, which requests to start a conference, in association with all the terminal IDs that are registered as candidates of the communication terminals 13 which become destinations to which data are transmitted.

The session management table refers to a table that manages selection session IDs, which are used to execute a session to select the relay apparatus 17, in association with the device ID of the relay apparatus 17, the terminal ID of the communication terminal 13 which is the request source, the terminal ID of the communication terminal which is the destination, etc. Further, this table manages in association with a delay time of the reception when the destination communication terminal 13 receives the image data, the date and time when the information of the delay time is received, etc.

The communication terminal 13 transmits image data which are acquired by imaging, display data of a screen to be shared such as a conference document input from the external input device 15, and voice data of input voices to the other communication terminal 13. Further, the communication terminal 13 transmits alternative data, which are provided in place of the imaging data acquired by capturing (imaging), to the other communication terminal 13. The alternative data are described below. Further, the communication terminal 13 receives the image data (the imaging data or the alternative data), and display data from the other communication terminal 13 and displays those data on the display 14. Further, the communication terminal 13 receives the voice data from the other communication terminal 13 and outputs the voices.

Here, it is assumed that the image data include at least the face of the participant of the conference, so that the facial expression of the participant can be seen based on the image data. The image data may be provided as an image data of an still image or moving image data. Further, the image data may include both the moving image data and the image data of the still image. The image data and the voice data can be distributed (transmitted) in a streaming distribution so that those data can be reproduced at the same time when those data are received.

The image data can be compression-coded and transmitted. As a technique for the compression-coding, various video encoding schemes in accordance with various standards can be employed. As an example of the standards, there is “H.264”, and “H.264/AVC” or “H.264/SVC” may be employed. In “H.264/SVC”, data are divided into plural channels and encoded, and transmitted. By doing this, the other party can combine the plural channels in accordance with a network state and the capability of the reproducing apparatus, so that failure-free and appropriate data can be extracted and reproduced.

The communication terminal 13 receives the image data (the imaging data or the alternative data), the display data, and the voice data from the other communication terminal 13. However, note that the number of the other communication terminals 13 is not limited to one. Therefore, the communication terminal 13 may receive the image data (the imaging data or the alternative data), the display data, and the voice data from two or more other communication terminals 13. In order to use a plurality of sets of the image data (the imaging data or the alternative data) and display plural images on the display 14, the communication terminal 13 divides the screen into one or more areas based on a location information which is previously set, and allocates the images to the areas. The images include not only videos of the faces of the participants, etc. but also images of the conference documents, etc.

The display 14 displays the image data, which are transmitted and received between communication terminals 13 connected to each other, and the display data of the conference document used for the conference. As the display 14, any device that can display those data may be used. For example, a liquid crystal display, an organic Electro Luminescence (EL) display or the like may be used.

The external input device 15 fetches, for example, the conference documents displayed on the display of the external input device 15 every predetermined time interval, and transmits the image data of the fetched image as the display data to the communication terminal 13 connected to the external input device 15 every predetermined time interval.

The display data refers to the data to display a screen to be shared displaying, for example, the conference document which is commonly used among plural communication terminals 13. The display data include, for example, document data, spread sheet data, and image data that are used by using document generation software, spread sheet software, presentation software, etc. The display data may also be provided as still image data or moving image data. Further, the display data may include both the moving image data and the still image data.

The router 16 selects an optimum route to transmit the image data, the display data, and the voice data. To that end, the router 16 stores a routing table in which the IP addresses of the router 16 and the communication terminal 13 of the transmission sources are associated with the IP addresses of the router 16 and the communication terminal 13 of the transmission destinations. The router 16 includes a storage section, so that the storage section stores the routing table. Besides the IP addresses, Media Access Control (MAC) addresses that uniquely identify the communication terminals 13 and the routers 16, the terminals IDs, terminal names, router names, etc., may be used. Those may be used along with the IP addresses. The IP address is not limited to the IP address in the IPv4. Namely, the IP address in the IPv6 may be used.

The relay apparatus 17 relays the transmission of the image data, etc., preformed between the communication terminals 13. To which communication terminal 13 the image data, etc., are to be transmitted and whether the transmission is to be stopped are determined based on the management information stored in the relay apparatus 17. In the remote conference system of FIG. 1, four relay apparatuses 17a through 17d are provided. Which of the relay apparatuses 17 is to be used is selected by the communication terminal 13 as described below.

Although not illustrated in FIG. 1, a maintenance system may be included in the remote conference system. The maintenance system refers to a computer that provides maintenance, management, and repair services for at least one of the management server 11, the program providing server 12, the communication terminal 13, and the relay apparatus 17. The maintenance system may be installed at any location (whether domestic or overseas) as long as the maintenance system can be connected to the Internet, so that it becomes possible to remotely provide those maintenance services to those servers and apparatuses via the Internet 10. Further, the maintenance system may provide a maintenance service to, for example, manage a model name, a manufacturing number, a sales destination, history of repair/maintenance or failures, etc., without using a network including the Internet 10.

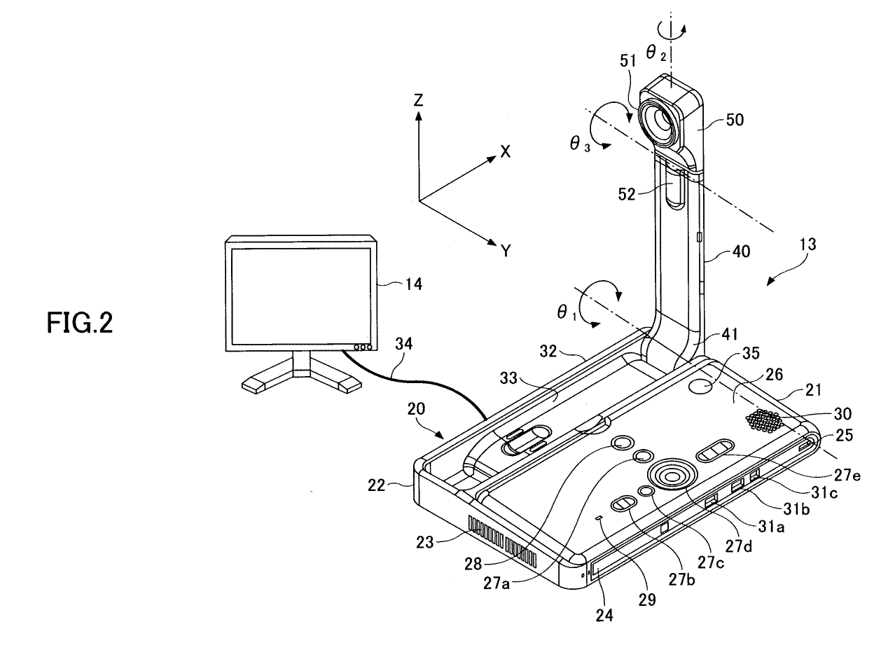

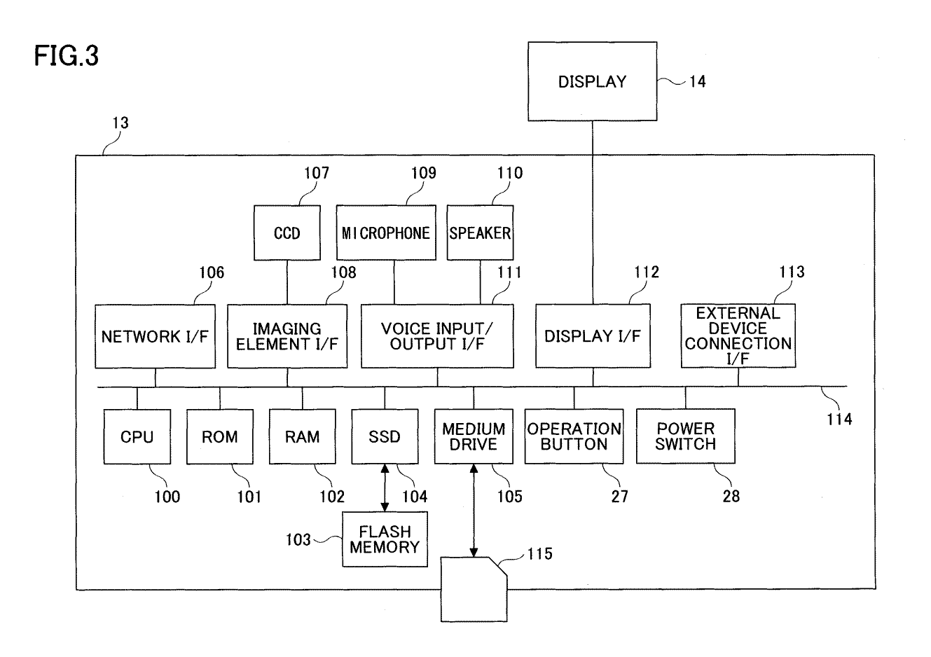

More details of the communication terminal 13 are described with reference to FIGS. 2 and 3. FIG. 2 illustrates an example exterior of the communication terminal 13. FIG. 3 illustrates an example hardware configuration of the communication terminal 13. As illustrated in FIG. 2, the communication terminal 13 is described, assuming that the longitudinal direction of the communication terminal 13 is the x axis direction, the direction orthogonal to the x axis direction in a horizontal plane is the y axis direction, and the direction (vertical direction) orthogonal to both the x axis direction and the y axis direction is the z axis direction.

The communication terminal 13 includes a chassis 20, an arm 40, and a camera housing 50. The chassis 20 includes a front-side wall surface 21 having an air intake surface (not shown) where plural air intake holes are formed, and a rear-side wall surface 22 having an air exhaust surface 23 where plural air exhaust holes are formed. Due to the structure, by driving a cooling fan installed inside the chassis 20, air can be introduced through the air intake surface (not shown) to use for cooling the inside of the chassis 20, and discharged from the air exhaust surface 23.

The chassis includes a right-side wall surface 24 where a sound collect hole 25 is formed, so that a built-in microphone, which is installed inside of the sound collect hole 25, can collect voices, sounds, and noise. Further, an operation panel 26 is formed on the side of the right-side wall surface 24. In the operation panel 26, there are provided plural operation buttons 27a through 27f, a power switch 28, an alarm lamp 29, and a sound output surface 30 where plural voice output holes are formed to pass output sound from a built-in speaker provided inside the chassis 20. Further, on the right-side wall surface 24 of the chassis 20,there are plural connecting ports 31a through 31c to connect to external devices using cables. Further, in the operation panel 26, an operation button to switch to enable/disable the function of a built-in-type camera 51 is provided. The function of the camera 51 is described below.

On a left-side wall surface 32 side in the chassis 20, a storage section 33 as a concave part is able to store the arm 40 and the camera housing 50. Further, on the left-side wall surface 32 of the chassis 20, a connecting port (not shown) is formed to connect to the display 14 using a cable 34.

The arm 40 is engaged with the chassis 20 via a torque hinge 41 in a manner so that the arm 40 is rotatably in up-and-down direction attached to the chassis 20 within a range of a tilt angle “θ1” of approximately 135 degrees relative to the chassis 20. Here, the term “tilt angle” refers to an angle based on which the inclination of the arm 40 can be changed in the up-and-down direction. In the example of FIG. 2, a state is illustrated where the tilt angle “θ1” is approximately 90 degrees.

The camera housing 50 includes the built-in-type camera 51 as an imaging means, so as to capture images of a participant in the conference, a document, scenery in a conference room, etc., as objects. A torque hinge 52 is provided on the camera housing 50, so that camera housing 50 is attached to the arm 40 via the torque hinge 52. In the case of FIG. 2, the camera housing 50 is rotatably attached to the arm 40 with a pan angle “θ2” within a range from −180 degrees to +180 degrees and with a tilt angle “θ3” within a range from −45 degrees to +45 degrees when 0 degrees of the angles are defined when the camera housing 50 is oriented relative to the arm 40 as illustrated in FIG. 2. The pan angle refers to an angle of the inclination that can be changed in the horizontal direction.

As illustrated in FIG. 3, in the communication terminal 13, a Central Processing Unit (CPU) 100 is provided (mounted) as hardware. Further, a Read-Only Memory (ROM) 101 and a Random Access Memory (RAM) 102 are provided. Further, a flash memory 103, a Solid State Drive (SSD) 104, a medium drive 105, the operation buttons 27, the power switch 28, and a network interface (I/F) 106 are provided. Further, a Charge Coupled Device (CCD) 107, an imaging element I/F 108, a microphone 109, and a speaker 110 are provided. Further, a voice input/output I/F 111, a display I/F 112, an external device connection I/F 113, the alarm lamp 29, and a bus line 114 are provided.

The CPU 100 controls the entire operations of the communication terminal 13. The ROM 101 stores a program which is executed by the CPU 100 to cause the communication terminal 13 to function as the means described below. The RAM 102 is used as a working area when the CPU 100 executes the program, etc. The flash memory 103 stores various data such as the image data, etc. The SSD 104 controls reading and writing various data from and to the flash memory 103 in accordance with the control by the CPU 100.

The medium drive 105 controls reading or writing (storing) data relative to a recording medium 115 such as a flash memory. The operation buttons 27 are operated to, for example, select the communication terminal 13 which becomes the destination. The power switch 28 switches enable power ON/OFF. The network I/F 106 connects the communication terminal 13 to a communication network, so that the communication terminal 13 can transmit and receive data via the communication network.

The CCD 107 is used as the built-in camera 51, captures images of a participant, etc., as objects in accordance with the control by the CPU 100, and acquires the image data of the images. Here, a CCD is employed in the camera 51. However, besides the CCD, for example, Complementary Metal Oxide Semiconductor (CMOS) or the like may be employed. The imaging element I/F 108 controls driving the CCD 107. The microphone 109 receives inputs of participant's voice and surrounding sound and noise.

The speaker 110 outputs sound of the voice data transmitted from other communication terminals 13. The voice input/output I/F 111 perform processes on the input/output of voice signals transmitted to and from the speaker 110 and the microphone 109 in accordance with the control by the CPU 100. The processes include, for example, noise cancelling, conversion from an analog signal to a digital signal, conversion from a digital signal to an analog signal, etc.

The display I/F 112 transmits the image data to the display 14, which is externally provided, in accordance with the control by the CPU 100. The external device connection I/F 113 transmits and receives various data to and from an external device. The alarm lamp 29 is turned on to notify a failure in various functions of the communication terminal 13. The bus line 114 refers to an address bus and a data bus to electrically connect the hardware elements described above to each other. Here, the address bus refers to a bus to be used to transmit a physical address indicating the location where data to be accessed are stored. The data bus refers to a bus to be used to transmit data.

The display 14 and the display I/F 112 are connected to each other via the cable 34. The cable 34 may be an analog RGB (VGA) signal cable or the a component video cable. Further, cable 34 may be a High-Definition Multimedia Interface (HDMI) cable or a Digital Video Interactive (DVI) cable.

As an example of the external device, there are an external camera, an external microphone, an external speaker, etc. The external device can be connected to the external device connection I/F 113 by using, for example, a Universal Serial Bus (USB) cable connected to the connection port 31 of the chassis 20. Further, when an external camera is connected as the external device, it is possible to drive the external camera with a higher priority than the camera 51 in accordance with the control by the CPU 100. In the same manner, when an external microphone or an external speaker is connected, it is also possible to drive those devices with a higher priority.

Here, it is assumed that the recording medium 115 can be detachably attached to the communication terminal 13. Further, it is assumed that the recording medium 115 is a readable/writable recording medium such as a Compact Disk ReWritable (CD-RW), a Digital Versatile Disk ReWritable (DVD-RW), a Secure Digital (SD) card, etc. In FIG. 3, the flash memory 103 is employed. However, note that any non-volatile memory that can have data read and written in accordance with the control by the CPU 100 may alternatively be used. Such a non-volatile memory includes an Electrically Erasable and Programmable ROM (EEPROM), etc.

Here, the program is stored in the ROM 101. However, the program may be stored in an installable format or an executable format in a recording medium in a manner such that the program stored in the recording medium can be read by the communication terminal 13. In the case of the system configuration of FIG. 1, a program which is provided from the program providing server 12 can be stored in the recording medium 115.

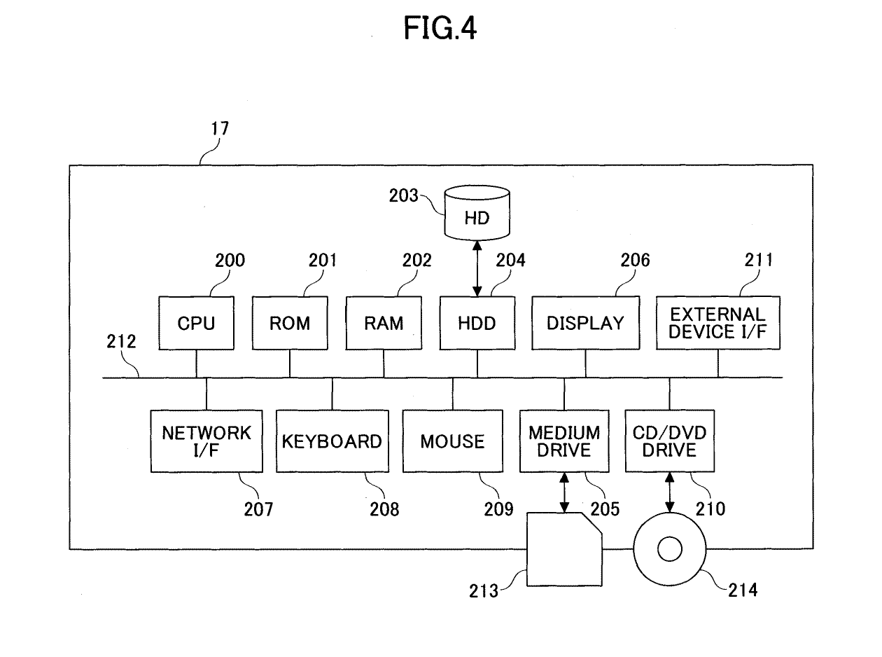

Next, an example hardware configuration of the management server 11, the program providing server 12, the external input device 15, and the relay apparatus 17 is briefly described with reference to FIG. 4. Due to the similar configurations, the configuration of the relay apparatus 17 is exemplarily described. Further, it is assumed that the maintenance system (not shown in FIG. 1) has a similar hardware configuration.

The relay apparatus 17 includes a CPU 200, a ROM 201, a RAM 202, a Hard Disk (HD) 203, and a Hard Disk Drive (HDD) 204. The relay apparatus 17 further includes a medium drive 205, a display 206, a network I/F 207, a keyboard 208, a mouse 209, a CD/DVD drive 210, an external device I/F 211, and a bus line 212.

The CPU 200 controls the operations of the entire relay apparatus 17. The ROM 201 stores a program which is executed by the CPU 200 to relay communications between the communication terminals 13. The RAM 202 is used as a working area when the CPU 100 executes the program, etc. The HD 203 stores various data. The HDD 204 controls reading and writing various data from and to the HD 203 in accordance with the control by the CPU 200.

The medium drive 205 controls reading or writing data relative to a recording medium 213 such as a flash memory. The display 206 displays various information such as a cursor, a menu, a window, characters, an image, etc. The network I/F 207 connects the relay apparatus 17 to a communication network, so that the relay apparatus 17 can transmit and receive data via the communication network. The mouse 209 is used to select various instructions, perform execution, select a target to be processed, move the cursor, etc.

The CD/DVD drive 210 controls reading and writing various data from and to the detachable recording medium 214 such as a CD-RW. The external device I/F 211 connects the relay apparatus 17 to an external device, so that the relay apparatus 17 can exchange information with the external device. The bus line 212 refers to an address bus, etc., to electrically connect the hardware elements described above to each other.

Here, the program is stored in the ROM 201. However, the program may be stored in an installable format or an executable format and stored in a recording medium such as the HD 203, the recording medium 213, etc., in a manner such that the program stored in the recording medium can be read by the relay apparatus 17. In the case of the system configuration of FIG. 1, a program which is provided from the program providing server 12 can be stored in the recording medium 213.

Next, a functional configuration of the communication terminal 13 is described with reference to a functional block diagram of the communication terminal 13 of FIG. 5. The communication terminal 13 includes a transmission/receiving section 300, an operation input receiving section 301, a log-in request section 302, an imaging section 303, an image display control section 304, a voice input section 305, and a voice output section 306. The communication terminal 13 further includes a selection processing section 307, an external information transmission/receiving section 308, a storage/reading processing section 309, a storage section 310, a location information selection section 311, and a display data control section 312. Those sections are realized by operating based on instructions from the CPU 100 in accordance with a program stored in the ROM 101.

The transmission/receiving section 300 is realized by the network I/F 106 of FIG. 3, and performs transmission and receiving various data and information with other communication terminals 13 via a communication network. The operation input receiving section 301 is realized by the operation buttons 27 and the power switch 28 of FIG. 3, and receives various inputs from a participant of the conference, especially from the user of this communication terminal 13. For example, when the user operates the power switch 28 ON, the operation input receiving section 301 detects the operation and sets the power to ON.

The log-in request section 302 is realized by an instruction from the CPU 100 of FIG. 3. In response to the setting the power to ON, the log-in request section 302 automatically transmits the log-in request information, which indicates the request to log in, and the current IP address of the communication terminal 13 from the transmission/receiving section 300 to the management server 11 of FIG. 1 via the communication network. Here, the log-in request information includes, for example, the terminal ID of the communication terminal 13, the password, etc.

The imaging section 303 is realized by the CCD 107 and the imaging element I/F 108. The imaging section 303 captures an image of an object such as a face of the user, converts the image into image data, and outputs the image data. The imaging section 303 can output any one of image data of a still image or moving image data or both. Further, the imaging section 303 can output the moving image in a form of streaming distribution via the transmission/receiving section 300.

The image display control section 304 is realized by the display I/F 112 of FIG. 3, and performs control to transmit the image data to the display 14.

The voice input section 305 is realized by the microphone 109 and the voice input/output I/F 111 of FIG. 3. The voice input section 305 inputs voice of the user, converts the input voice into voice data, and outputs the voice data. The voice input section 305 measures the signal level of the input signal and determines whether there exists a voice signal by comparing the measured signal level with a threshold value, etc. When determining that there exists a voice signal, the voice input section 305 converts the voice signal into voice data and outputs the voice data. The voice output section 306 is realized by the speaker 110 and the voice input/output I/F 111 of FIG. 3. The voice output section 306 converts the voice data, which are received from the other communication terminal 13, into voice, and outputs the voice.

The selection processing section 307 is realized by an instruction from the CPU 100 of FIG. 3, and performs a process of selecting one relay apparatus 17 to determine which of the plural relay apparatuses 17a through 17d is to be used to relay to transmit and receive data. The selection processing section 307 includes, for example, a measurement section, a calculation section, and a selection section, so as to select the one relay apparatus 17 by using those sections.

The measurement section measures receiving date and time when prior transmission information is received by the transmission/receiving section 300 for each of the prior transmission information items which is received by the transmission/receiving section 300 and includes transmission date and time. Here, the prior transmission information refers to the information which is transmitted to the other communication terminals via the relay apparatus 17 before the transmission of image data, etc., and which is used to measure a required time from the communication terminal of the request source (request source terminal) to the communication terminal of the destination (destination terminal). The prior transmission information includes, for example, “ping” to determine whether the request terminal and the destination terminal are connected to each other in a manner such that the request terminal and the destination terminal can communicate with each other, and the transmission date and time when the prior transmission information is transmitted. The prior transmission information further includes, for example, a session ID which identifies a series of communications (session) from a conference that starts by logging in to the conference and ends by logging off.

The calculation section calculates a required time which is from the transmission to the receiving of the prior transmission information by calculating the difference thereof by using the measured receiving time and the transmission date and time included in the prior transmission information sets for each of the prior transmission information whose receiving date and time is measured by the measurement section. The selection section selects the relay apparatus 17 having a shortest required time by comparing the required times of the relay apparatuses 17 with each other, the required time being calculated by the calculation section. By doing this, it becomes possible to select one relay apparatus 17 from among the plural relay apparatuses 17a through 17d.

The external information transmission/receiving section 308 is realized by the external device connection I/F 113 of FIG. 3. The external information transmission/receiving section 308 performs a process of receiving data from an external device and transmitting data to the external device. In a case where the external device is an external camera or an external microphone, the external information transmission/receiving section 308 receives the image data from the external camera or the voice data from the external microphone, respectively. In a case where the external device is an external speaker, the external information transmission/receiving section 308 transmits voice data to the external speaker.

The storage/reading processing section 309 is realized by the SSD 104 of FIG. 3. The storage/reading processing section 309 performs processes of storing various data in the storage section 310 and reading various data stored in the storage section 310. The storage section 310 stores, for example, the terminal ID to identify the communication terminal 13, the password, the image data, the voice data, a relay apparatus ID which is to identify the relay apparatus 17 transmitting other various data, the IP address of the destination terminal, etc. The storage section 310 further stores a location information management table 313, a transmission management table 314, an event flag table 315, etc. The storage section 310 may further store alternative data 501 which are prepared in advance.

The location information selection section 311 selects a shared flag from the event flag table 315 stored in the storage section 310 based on a distribution event of the display data. Then, the location information selection section 311 sets the selected shared flag in the location information management table 313 and sends an instruction indicating the location information of the screen to be displayed on the display 14 to the image display control section 304. As the distribution event, there are a “distribution start event” which occurs when the distribution of the display data starts, a “distribution stop event” which occurs when the distribution is stopped, etc. Further, the distribution events include a “distribution start event from another terminal” which occurs when the distribution of display data from the other communication terminal 13 starts, and a “distribution stop event from another terminal” which occurs when the distribution of display data from the other communication terminal 13 stops.

In the case of the “distribution start event” and the “distribution start event from another terminal”, the distribution of the display data is started, so that the communication terminal 13 receives the display data. In this regard, the location information selection section 311 instructs the location information indicating the display of the display data.

The display data control section 312 acquires the display data from the external input device 15, and performs control to transmit the acquired display data to the communication terminal 13. The display data may be referred to as the image data of an image which is displayed in the screen on the display of the external input device 15 in a file format such as Joint photographic Experts Group (JPEG), bit map, etc. The display data may further be referred to as a draw command using a file format such as Graphic Device Interface (GDI), etc.

In response to a request from the external input device 15, the display data control section 312 sends a request to start the distribution of the display data or a request to stop the distribution of the display data to the relay apparatus 17. Further, the display data control section 312 refers to the event flag table 315 in accordance with the distribution event from the relay apparatus 17, determines a state of a display control flag, and transmits the display control flag to the external input device 15. The display control flag refers to a flag to be used for the communication terminal 13 to control the display of a menu, etc., to be displayed on the own display of the external input device 15.

Here, the event flag table 315 refers to a table in which the types of the events such as the “distribution start event”, the shared flag indicating whether the communication terminal 13 shares the display data, and the display control flag are managed in association with each other. The location information management table 313 refers to a table in which the location information and the shared flag are managed in association with each other.

The transmission management table 314 refers to a table in which the transmission information is managed indicating whether the image data, which are acquired by being captured by the imaging section 303, are transmitted to the relay apparatus 17 and the display data, which are input from the external input device 15, are transmitted to the relay apparatus 17.

For example, when the reception of the display data from the external input device 15 stops, so that the distribution stop event occurs, the location information selection section 311 sets the shared flag, which indicates that the display data are not shared, in the location information management table 313, and sends an instruction of the location information to the image display control section 304 so that the screen display does not include the display data. Upon the receipt of the instruction, the image display control section 304 switches the screen which is currently displayed, and changes the transmission state in the transmission data in the transmission management table 314.

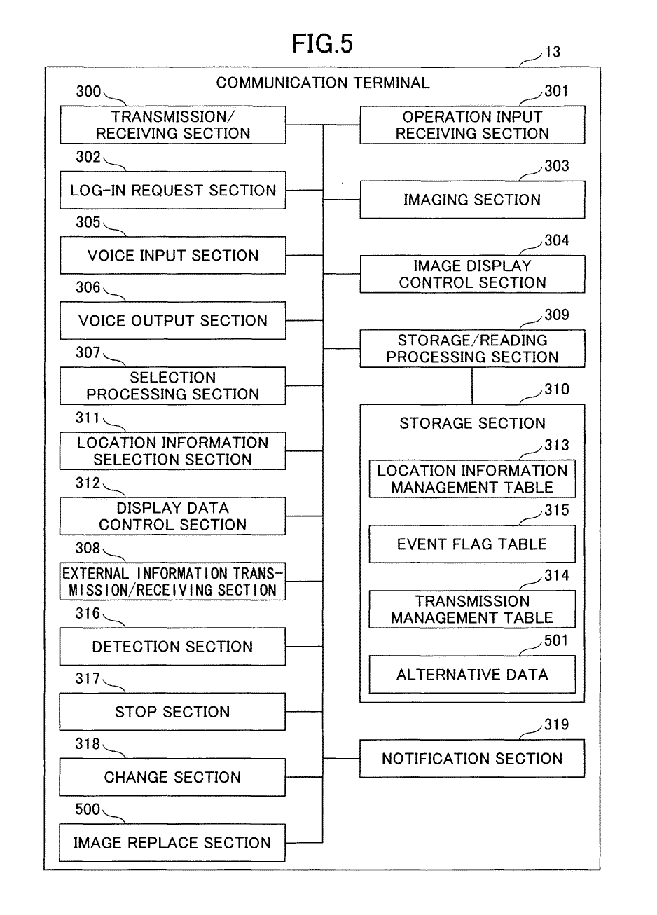

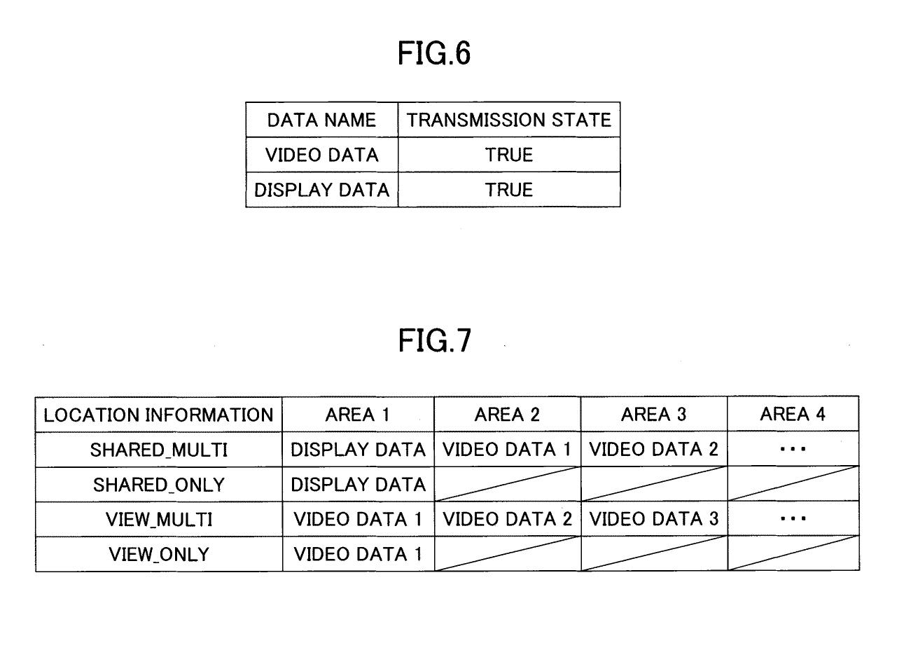

FIG. 6 illustrates an example of the transmission management table 314. The transmission management table 314 manages a data name, which identifies the data to be transmitted to the relay apparatus 17, and corresponding transmission state in association with each other. The data name refers to the “video data” which is an example of the image data, the “display data”, etc. The transmission state refers to the information indicating whether it is under transmission, so that “TRUE” is set when in transmission and “FALSE” is set when not in transmission. Note that the table of FIG. 6 is an example only. For example, the transmission management table 314 may further include the information indicating conference name, the date and time, the type of data, etc. In the following description, it is assumed that the image data are video data.

The storage section 310 may further store a table as illustrated in FIG. 7. FIG. 7 is a table illustrating relationships between the location information and the video data and display data which are allocated in the areas which are acquired by dividing the screen into plural areas. The location information refers to the information related to the displays of the video data and the display data. As the location information, there are “SHARED_MULT”, “SHARED_ONLY”, “VIEW_MULT”, “VIEW_ONLY”, etc.

The “SHARED_MULT” refers to a state where all the video data and the display data from the communication terminals 13 used in the same conference are displayed in a mixed manner. The “SHARED_ONLY” refers to a state where only the display data are enlarged and displayed. The “VIEW_MULT” refers to a state where all the video data from the communication terminals 13 used in the same conference are displayed and the display data are not displayed. The “VIEW_ONLY” refers to a state where only one specific video data among all the video data are enlarged and displayed.

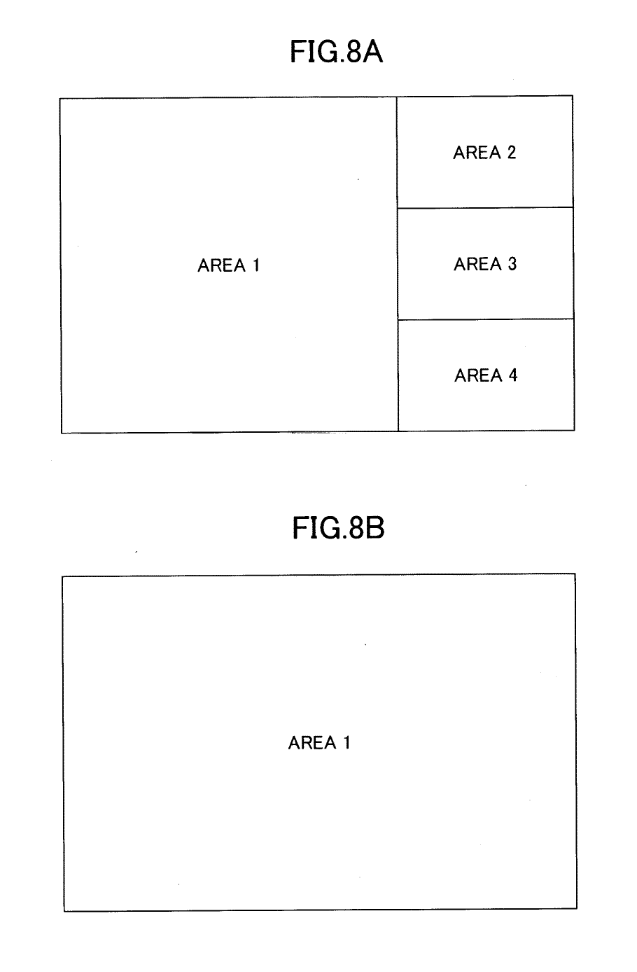

The image display control section 304 refers to this table, determines in which manner the data are displayed based on the location information instructed by the location information selection section 311. FIGS. 8A and 8B illustrate how the display is actually divided.

FIG. 8A illustrates a case where the “SHARED_MULT” or “VIEW_MULT” is selected as the location information. Here, only the areas 1 through 4 are displayed. However, actually, in the case of “SHARED_MULT”, the display data are displayed in the area 1 and the video data are displayed in the areas 2 through 4. In other words, the conference document, etc., is displayed in the area 1, and the videos of the other parties are displayed in the areas 2 through 4. In the case of “VIEW_MULT”, the video data 1 are displayed in the area 1 and the video data 2 through 4 are displayed in the areas 2 through 4, respectively.

FIG. 8B illustrates a case where the “SHARED_ONLY” or “VIEW_ONLY” is selected as the location information. Here, only the area 1 is displayed. Similar to the case in FIG. 8A, however, actually, in the case of “SHARED_ONLY”, the display data are enlarged and displayed in the area 1. In the case of “VIEW_ONLY”, the video data are enlarged and displayed in the area 1. Here, since only one display data or video data are displayed, it is possible to enlarge the area 1 of FIG. 8A. Therefore, the area 1 is enlarged in FIG. 8B. Note that, however, the display manner according to an embodiment is not limited to this example. For example, one data may be displayed in the same size, or the data may be enlarged or reduced to any size by using enlarge and reduce buttons which are separately provided.

Further, in FIG. 8A, the display is divided in a manner such that the area 1 is larger and the areas 2 through 4 have the same size and are smaller than the area 1. However, the display manner according to an embodiment is not limited to this example. For example, the display may be divided in a manner such that all the areas have the same size, and the number of the areas may be two or three, or five or more. Further, when the video data are displayed, the received voice data are reproduced along with the display of the video data. Therefore, it is possible to know which of the users is currently talking and about what the user talks.

As illustrated in FIG. 5, the communication terminal further includes a detection section 316, a stop section 317, a change section 318, a notification section 319, and an image replace section 500. Here, the configuration including the change section 318 and the notification section 319 is described. However, those sections may not be included. Those sections can be realized by the configuration elements of FIG. 3 by operating on the instructions from the CPU 100 in accordance with a program stored in the ROM 101.

The detection section 316 detects an event, which is determined in advance, to make it unnecessary to transmit data while capturing the images is continuously performed. Note that this event does not refer to the press-down of the record stop button, because capturing the images is continuously performed. Examples of this event are described below.

As one example, there is a case where the camera 51, which captures an image and outputs the video data, is housed in the storage section 33. In this case, it is possible for the camera 51 to capture an image but cannot capture an image of the user, etc. Therefore, it is not necessary to transmit the video data. More specifically, a case when the arm 40 of the communication terminal 13 of FIG. 2 is folded applies to this case. Further, a case when the camera 51 is covered with a protection member, that is when a cap is on the camera 51, also applies to this case.

Further, there is a case where after the external input device 15, which is to input display data in the communication terminal 13, is connected to the communication terminal 13, the communication terminal 13 starts transmitting/receiving data with the other communication terminals 13, that is, the conference is started. This is because when the external input device 15 is connected to the communication terminal 13 before the conference starts, in order for the users of all the other communication terminals 13 in the same conference to focus only on the display data, what is necessary is to transmit only the display data and accordingly it becomes unnecessary to transmit the video data.

As another example, there is a case where a notification is received from the relay apparatus 17 which indicates that none of the other communication terminals 13 in the same conference uses the video data transmitted from the communication terminal 13. Since none of the other communication terminals 13 uses the video data, it becomes unnecessary to transmit the video data although the video data are being captured.

Note that the event is not limited to the examples described above. For example, there is a case when a user performs a mode setting so that only the display data are to be transmitted by using a User Interface (UI) by the user. Further, the event may indicate that the conference starts while the arm 40 is still folded.

In response to the detection of the event, the stop section 317 sends an instruction to the imaging section 303 to stop capturing images and sends an instruction to the transmission/receiving section 300 to stop transmitting the video data. Then, after the stoppings, the stop section 317 cuts off power to the imaging section 303, that is the camera 51. By stopping the image capturing and the transmission of the video data as described above, it becomes possible to reduce the use rate and energy consumption of the CPU 100. Further, by stopping power to the imaging section 303, it becomes possible to further reduce the energy consumption.

In response to the detection of such an event, the change section 318 changes the content which is set in the transmission management table 314 as the transmission information. Specifically, when a state that the arm 40 is folded is detected as an event, the event indicates that the camera function is not used. The change section 318 changes the setting so as to stop the transmission of the image data. When it is described with reference to FIG. 6, the setting “TRUE” of the video data is changed to “FALSE”.

Further, when an event is detected that a conference is started after a cable connected to the external input device 15 is inserted into, for example, the connecting port 31a, it is desired for the users of the other communication terminals 13 to focus on only the display data. Therefore, it is not necessary to transmit the video data, and the setting is changed to stop the transmission of the video data. Further, when it is detected that all the other communication terminals 13 as well as the own communication terminal 13, which are used in the same conference, are not using the video data captured by the own communication terminal 13, no communication terminal 113 uses the video data. Therefore, the setting is changed to stop the transmission of the video data.

The notification section 319 notifies the relay apparatus 17 of the transmission management table 314 after the change section 318 changes the setting. The relay apparatus 17 receives the notification, and changes the management information, which is stored in and managed by the relay apparatus 17, described below. The notification section 319 may transmit the transmission management table 314 and may be transmit only the part where the change is made.

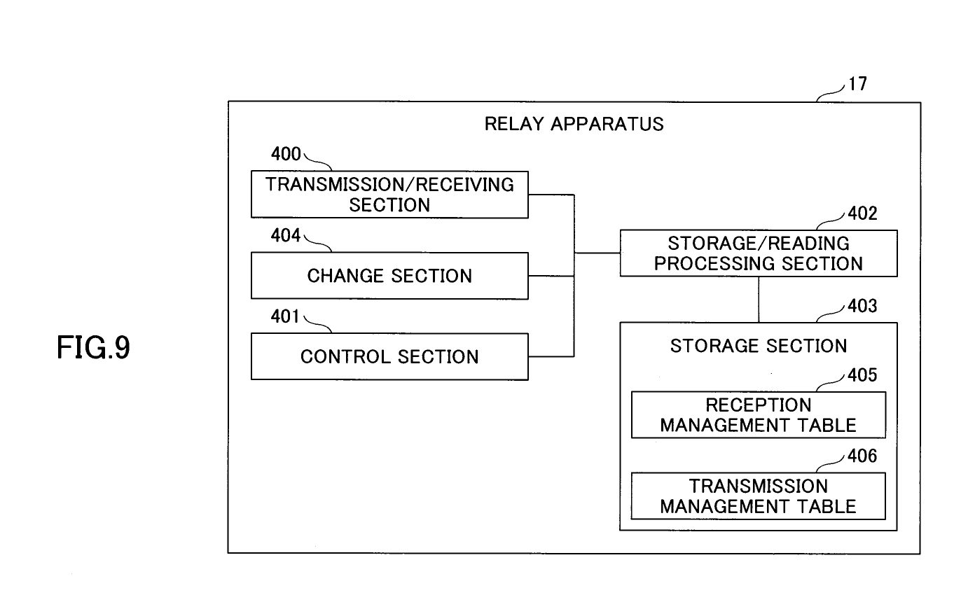

Here, a functional configuration of the relay apparatus 17 is briefly described with reference to FIG. 9. The relay apparatus 17 includes a transmission/receiving section 400, a control section 401, a storage/reading processing section 402, a storage section 403, and a change section 404.

The transmission/receiving section 400 is realized by the network I/F 207 of FIG. 4. When the location information is changed in the communication terminal 13 and when the transmission management table 314 is changed, the transmission/receiving section 400 receives the changed location information and the transmission management table 314 which are notified by the communication terminal 13.

The control section 401 is realized by an instruction from the CPU 200 of FIG. 4. The control section 401 sends an instruction to the storage/reading processing section 402 so that the storage/reading processing section 402 can receive data in accordance with the content set in a reception management table 405 which is stored as management information in the storage section 403. Further, the control section 401 performs control so that the received data can be transmitted in accordance with the content set in a transmission management table 406.

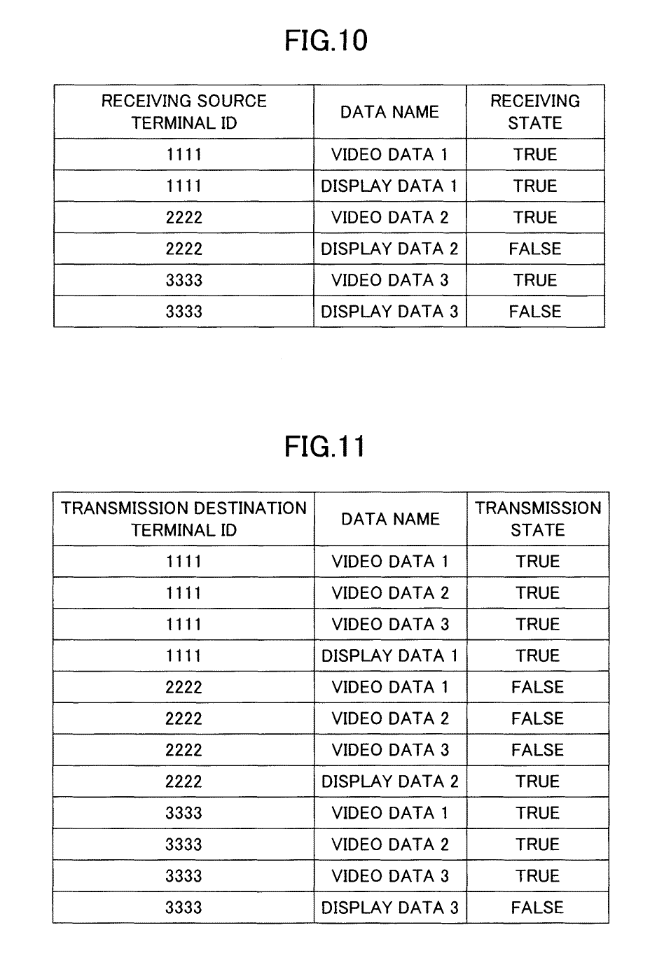

FIG. 10 illustrates an example of the reception management table 405 which is stored by the relay apparatus 17 and is one of the management information sets which are managed. The reception management table 405 manages the terminal ID indicating from which of the communication terminals 13 the video data or the display data as the image data are received, a data name to identify the received video data or the display data (identify whether the received data are the video data or the display data), and a receiving state in association with each other. The receiving state refers to the information indicating whether the relay apparatus 17 is receiving data. When data are being received, “TRUE” is set, and when no data are being received,

“FALSE” is set.

Here, the terminal ID is used. However, for example, the terminal name, the IP address, the MAC address, the installation place (e.g., Tokyo office) may alternatively be used as long as the communication terminal 13 can be identified.

FIG. 11 illustrates an example of the transmission management table 406 which is one of the management information sets to be managed. The transmission management table 406 manages the terminal ID indicating to which of the communication terminals 13 the video data or the display data as the image data are transmitted, the data name to identify the receiving video data or the display data (identify whether the transmitted data are the video data or the display data), and a transmission state in association with each other. The transmission state refers to the information indicating whether the relay apparatus 17 is transmitting data. When data are being transmitted, “TRUE” is set, and when no data are being transmitted, “FALSE” is set. Similar to the reception management table 405 of FIG. 10, it is not limited to the terminal ID, and the terminal name, the IP address, etc., may alternatively be used.

Referring back to FIG. 9, the location information, which is received by the transmission/receiving section 400, or the transmission management table 314 is transmitted to the change section 404. Then, the change section 404 sends an instruction to the storage/reading processing section 402, so that the storage/reading processing section 402 reads the reception management table 405 or the transmission management table 406. Then, the change section 404 changes the receiving state in the reception management table 405 in accordance with the content of the transmission management table 314 or changes the transmission state in the transmission management table 406 in accordance with the content of the location information.

When, for example, the transmission management table 406 is changed and the transmission state of a certain communication terminal 13 is set to “FALSE”, the transmission from the relay apparatus 17 to the certain communication terminal 13 is stopped. Therefore, the workload of the network can be reduced. The relay apparatus 17 may include a determination section and a notification section in additions to the above sections. The determination section can determine whether there are the video data that are not being transmitted to any of the communication terminals 13. When it is determined that there are the video data that are not being transmitted to any of the communication terminals 13, the notification section can send a notification to all the communication terminals 13 that transmit the video data so as to stop the transmission of the video data. By doing this, the transmission of the video data from the communication terminals 13 to the relay apparatus is stopped, so that the workload of the network can further be reduced.

Further, when the determination section determines that none of the video data are being transmitted to any of the changed transmission management tables 406 in any of the communication terminals 13, the control section 401 can stop the transmission of all the video data to all of the communication terminals 13. In this case, the notification section can send a notification to all the communication terminals 13 that transmit the video data to stop the transmission of the video data. The determination section and the notification section are realized by the instructions from the CPU 200 of FIG. 4.

Next, the image replace section 500 is described. When an operation button 35 to disable the function of the camera 51 is operated, an image replace section 500 according to this embodiment reads an alternative data 501 stored in the storage section 310, and replaces the imaging data, which are captured by the camera 51, with the alternative data 501. The alternative data 501 are transmitted to the other communication terminals 13 included in the remote conference system by the transmission/receiving section 300. Here, the imaging data according to this embodiment include moving image data and still image data.

In this case, according to this embodiment, the transmission state of the video data in the transmission management table 314 remains “TRUE”.

In the following, a case is described where, for example, the operation button 35 is operated in the communication terminal 13.

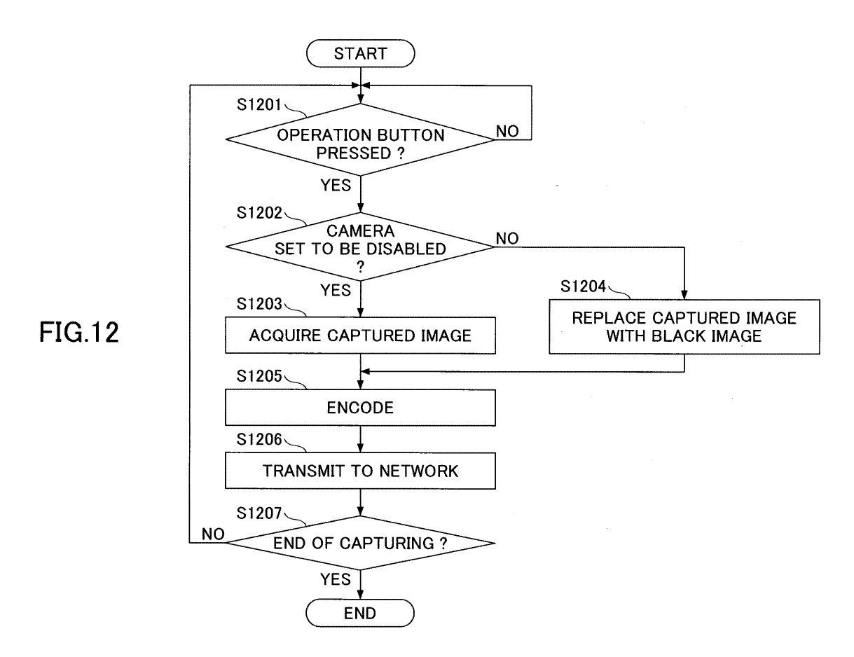

FIG. 12 is a flowchart illustrating a process performed by the communication terminal 13 when the camera function is disabled.

In the communication terminal 13, the image replace section 500 determines whether the operation button 35 is operated (step S1201). More specifically, the image replace section 500 determines whether the operation button 35 is pressed down. When it is determined that the operation button 35 is not operated (NO in step S1201), the communication terminal 13 waits until the operation button 35 is operated.

In step S1201, when it is determined that the operation button 35 is operated (YES in step S1201), the communication terminal 13 further determines whether the function of the imaging section 303 (camera 51) is set to be disabled (step S1202).

When it is determined that the function of the camera 51 is set to be disabled (YES in step S1202), the image replace section 500 cancels the disable setting of the camera function, and the imaging section 303 acquires the captured imaging data (step S1203). Then, the process goes to step S1205.

When it is determined that the function of the camera 51 is not set to be disabled (NO in step S1202), that is when no imaging data are output from the imaging section 303, the image replace section 500 replaces the imaging data, which are not being output from the imaging section 303, with the alternative data 501 stored in the storage section 310 (step S1204).

Next, the communication terminal 13 encodes the imaging data or the alternative data 501 (step S1205), and the transmission/receiving section 300 transmits the encoded data to the other communication terminals 13 via a network (step S1206).

Next, the communication terminal 13 determines whether an instruction to stop the capturing is received (step S1207). Here, the capturing in this embodiment refers to a process to acquire the image data to start a conference and display own videos.

When determining that the instruction to stop the capturing is received (YES in step S1207), the process ends. When it is detected that the capturing is in process in step S1207, the process goes back to step S1201.

Here, the alternative data 501 according to this embodiment is described. The alternative data 501 according to this embodiment may be, for example, the image data of a black image. Here, in this embodiment, it is assumed that the alternative data 501 are stored in the storage section 310 in advance. However, the present invention is not limited to this configuration. For example, the alternative data 501 may alternatively be generated by burying in the memory area, where images are to be transmitted, bits indicating black.

As described above, when the function of the camera 51 is set to be disabled, the communication terminal 13 according to this embodiment transmits the alternative data 501 in place of the imaging data to the other communication terminals 13. The other communication terminals 13, which receive the alternative data 501, display the alternative data 501 in the area, where the imaging data were previously displayed, in the displays 14.

Therefore, according to this embodiment, it becomes possible to easily know that the party that disables the function of the camera continuously participates in the conference even when the imaging data are not transmitted to the other parties.

Further, in this embodiment, the alternative data 501 are encoded and compressed, and then, transmitted to the network. In this case, all the image data between the previous and the next data can be set as a black image, so that it becomes possible to increase the compression rate. Therefore, according to this embodiment, by transmitting the alternative data 501, it becomes possible to reduce the workload related to the communication band and it also becomes possible to reduce influence on the communication band.

Further, in this embodiment, it is assumed that the alternative data 501 are the image data of a black image. However, the present invention is not limited to this configuration. As the alternative data 501 according to this embodiment, any image data of a still image may be used as long as the image data indicate that the function of the camera 51 is set to be disabled. Specifically, for example, image data of a scenery image or image data including a message indicating that the function of the camera 51 is set to be disabled may be used. The alternative data 501 in this case is assumed that when encoded, the data size is smaller than that of the imaging data captured by the camera 51. By doing this, and by transmitting the alternative data 501, it becomes possible to reduce an influence on the communication band.

Further, in the example of FIG. 12, a case is described where the function of the camera 51 is set to be enabled and disabled by operating the operation button 35. However, the present invention is not limited to this configuration. For example, the function of the camera 51 may be set to be enabled and disabled by operating a switch button displayed on the display 14.

Next, a case where the communication terminal 13 receives the alternative data 501 is described. In the following description, a case is described where a remote conference is conducted using the communication terminals 13a, 13b, 13e, and 13f.

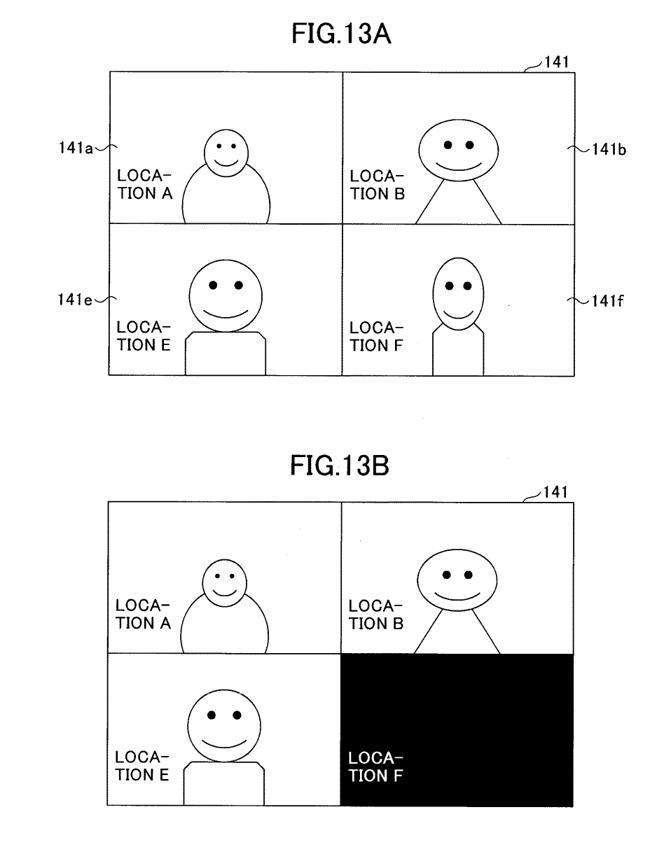

FIGS. 13A and 13B illustrate cases where the communication terminal 13 receives the alternative data 501. FIGS. 13A and 13B illustrate example screens on the display 14a connected to the communication terminal 13a. FIG. 13A illustrates an example screen displayed on the display 14a when the function of the camera 51 of the communication terminal 13f is enabled. FIG. 13B illustrates an example screen displayed on the display 14a when the function of the camera 51 of the communication terminal 13f is disabled.

In FIG. 13A, the display 14a displays the imaging data, which are captured by the camera of the communication terminal 13a, and the imaging data which are captured by the cameras of the communication terminals 13b, 13e, and 13f.

Specifically, a screen 141, which is displayed on the display 14a, is divided into four areas 141a , 141b, 141e, and 141f. Namely, the screen 141 is divided into the same number of the areas as that of the communication terminals 13 participating in the conference.

In the area 141a, the imaging data are displayed captured by the camera 51 that is mounted on the communication terminal 13a. In the area 141b, the imaging data, which are received from the communication terminal 13b, are displayed. In the area 141e, the imaging data, which are received from the communication terminal 13e, are displayed. In the area 141f, the imaging data, which are received from the communication terminal 13f, are displayed.

Therefore, it is possible for the participant of the conference using the communication terminal 13a to easily know that the number of the current participants is four.

On the other hand, in FIG. 13B, in the area 141f of the screen 141, a black image is displayed, which is the alternative data 501 received from the communication terminal 13f. This is because the function of the camera 51 is set to be disabled in the communication terminal 13f. In this case, however, similar to the case of FIG. 13A, the status is maintained where the screen is divided into the same number of the areas as that of the communication terminals 13 participating in the conference.

Namely, the communication terminal 13 according to this embodiment divides the screen of the display 14a into the same number of the areas as that of the communication terminals 13 participating the conference. Further, the communication terminal 13 controls the display on the display 14a in a manner such that the data, which are to be transmitted to the other communication terminals 13 from the communication terminal 13, are displayed in one of the areas and the data, which are received from the other communication terminals 13, are displayed in the other areas.

In the embodiment, by controlling the display as described above, in a case where, for example, the function of the camera 51 of the communication terminal 13a is set to be disabled, the alternative data 501 are displayed in the area 141a of the display 141 and the imaging data, which are transmitted from the other communication terminals 13b, 13e, and 13f, are displayed in the other areas.

Therefore, the participant of the conference using the communication terminal 13a can easily know that the number of the current participants is four similar to the case of the display 141 in FIG. 13A. Further, it is also possible to know that the participant of the communication terminal 13f sets the function of the camera 51 to be disabled.

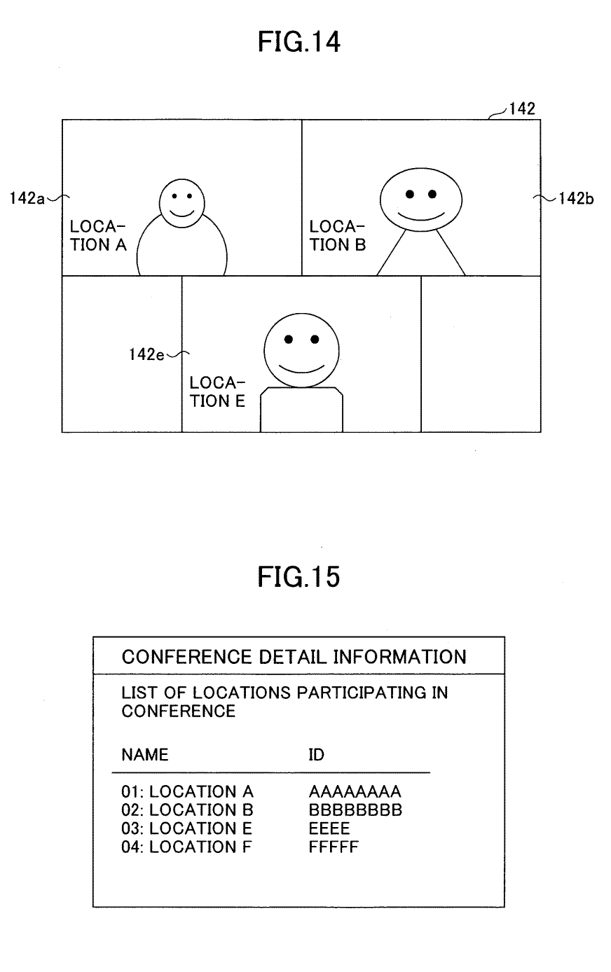

Further, in this embodiment, it is possible for the communication terminal 13a which receives the alternative data 501 to display the screen 141 of FIG. 14B on the display 14a simply by displaying the data, which are received from the communication terminal 13f, on the area 141f. Therefore, in this embodiment, it becomes possible for the participant using the communication terminal 13a to know the current participants of the conference without performing a specific process in the communication terminal 13a that receives the alternative data 501.

In the following, effects according to this embodiment area described with reference to FIGS. 14 and 15. FIG. 14 illustrates a comparative example illustrating an effect according to this embodiment. FIG. 15 illustrates an example list of the participants of the conference.

The comparative example of FIG. 14 illustrates a case where the function of the camera 51 of the communication terminal 13f is set to be disabled in a state similar to that of FIG. 13.

In the example of FIG. 14, the state of the communication terminal 13f, where the function of the camera 51 is set to be disabled, is that the transmission of the image data captured by the camera 51 is stopped. Due to this, in the screen 142 of FIG. 14, no area is generated where the imaging data, which are transmitted from the communication terminal 13f, are to be displayed. As a result, the imaging data of the communication terminal 13a and the imaging data which are transmitted from the communication terminals 13b and 13e are displayed.

Therefore, the number of the areas in the screen 142 is not the same as that of the communication terminals 13 participating in the conference. Due to this, in a case where, for example, the participant using the communication terminal 13f does not talk, it is difficult to know whether the communication terminal 13f participates in the conference.

In such a case, to know the participants of the conference, the communication terminal 13 acquires a list of participants who participate in the conference as illustrated in FIG. 15 from, for example, the management server 11.

In this case, it becomes possible to know that the number of the participants is four based on the list of participants who participate in the conference in FIG. 15, although the images of only three participants are displayed on the screen 142 of FIG. 14.

On the other hand, in this embodiment, even when, for example, the function of the camera 51 of the communication terminal 13f is set to be disabled, in the screen 141 on the display 14a connected to the communication terminal 13a, the state is maintained where the number of the areas is the same as that of the communication terminals 13 participating in the conference.

According, in this embodiment, it becomes possible to know the participants without referring to the list of participants of the conference as illustrated in FIG. 15.

Further, in the above embodiment, a case is described where the communication terminal 13 receives the imaging data and the alternative data from the other communication terminal 13 via the relay apparatus 17, and displays those data on the display 14. However, the present invention is not limited to this configuration. According to this embodiment, the relay apparatus 17 may generate the imaging data of the images, which are to be displayed on the displays 14 connected to the communication terminals 13, based on the imaging data and the alternative data transmitted from the communication terminals 13, and transmit the generated image data to the communication terminals 13. Further, according to this embodiment, the management server 11 may generate the above-described imaging data of the screen on the display 14.

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

The present application is based on and claims the benefit of priority of Japanese Patent Application No. 2014-152135 filed Jul. 25, 2014, the entire contents of which are hereby incorporated herein by reference.

### DESCRIPTION OF THE REFERENCE NUMERALS

10: THE INTERNET
11: MANAGEMENT SERVER
12: PROGRAM PROVIDING SERVER
13, 13a-13h: COMMUNICATION TERMINAL
14, 14a-14h: DISPLAY
15, 15a-15h: EXTERNAL INPUT DEVICE
16, 16a-16f: ROUTER
17, 17a-17d: RELAY APPARATUS
18, 18a-18d: LAN
19a, 19B: DEDICATED LINE
20: CHASSIS
21: FRONT-SIDE WALL SURFACE
22: REAR-SIDE WALL SURFACE
23: AIR EXHAUST SURFACE
24: RIGHT-SIDE WALL SURFACE
25: SOUND COLLECT HOLE
26: OPERATION PANEL
27A-27E: OPERATION BUTTONS
28: POWER SWITCH
29: ALARM LAMP
30: SOUND OUTPUT SURFACE
31A-30C: CONNECTING PORT
32: LEFT-SIDE WALL SURFACE
33: STORAGE SECTION
34: CABLE
40: ARM
41: TORQUE HINGE
50: CAMERA HOUSING
51: CAMERA
52: TORQUE HINGE
100: CPU
101: ROM
102: RAM
103: FLASH MEMORY
104: SSD
105: MEDIUM DRIVE
106: NETWORK I/F
107: CCD
108: IMAGING ELEMENT I/F 108
109: MICROPHONE
110: SPEAKER
111: VOICE INPUT/OUTPUT I/F
112: DISPLAY I/F
113: EXTERNAL DEVICE CONNECTION I/F
114 BUS LINE
115: RECORDING MEDIUM
200: CPU
201: ROM
202: RAM
203: HD
204: HDD
205: MEDIUM DRIVE
206: DISPLAY
207: NETWORK I/F
208: KEYBOARD
209: MOUSE
210: CD/DVD DRIVE
211: EXTERNAL DEVICE I/F
212: BUS LINE
213: RECORDING MEDIUM
214: RECORDING MEDIUM
300: TRANSMISSION/RECEIVING SECTION
301: OPERATION INPUT RECEIVING SECTION
302: LOG-IN REQUEST SECTION
303: IMAGING SECTION
304: IMAGE DISPLAY CONTROL SECTION
305: VOICE INPUT SECTION
306: VOICE OUTPUT SECTION
307: SELECTION PROCESSING SECTION
308: EXTERNAL INFORMATION TRANSMISSION/RECEIVING SECTION
309: STORAGE/READING PROCESSING SECTION
310: STORAGE SECTION
311: LOCATION INFORMATION SELECTION SECTION
312: DISPLAY DATA CONTROL SECTION
313: LOCATION INFORMATION MANAGEMENT TABLE
314: TRANSMISSION MANAGEMENT TABLE
315: EVENT FLAG TABLE
316: DETECTION SECTION
317: STOP SECTION
318: CHANGE SECTION
319: NOTIFICATION SECTION
400: TRANSMISSION/RECEIVING SECTION
401: CONTROL SECTION
402: STORAGE/READING PROCESSING SECTION
403: STORAGE SECTION
404: CHANGE SECTION
405: RECEPTION MANAGEMENT TABLE
406: TRANSMISSION MANAGEMENT TABLE
500: IMAGE REPLACE SECTION

### PRIOR ART DOCUMENTS

### Patent Document

[Patent Document 1] Japanese Laid-open Patent Publication No. 2014-90231

1. A remote conference system comprising:
a plurality of communication terminals having respective imaging units and connected to each other via a network,
wherein one of the communication terminals includes
a transmission unit configured to transmit alternative data that differ from imaged data that are captured by the imaging unit to the other communication terminals when a function of the imaging unit is set to be disabled, and
a display control unit configured to display a screen including the alternative data transmitted from one of the other communication terminals on a display device.

2. The remote conference system according to claim 1,
wherein the display control unit is configured to display the screen that includes the alternative data transmitted from the other communication terminal and imaging data that are captured by the communication terminal other than the communication terminal that transmits the alternative data among the other communication terminals.

3. The remote conference system according to claim 1,
wherein the alternative data are image data having a data amount smaller than the data amount of the imaging data.

4. The remote conference system according to claim 1,
wherein the alternative data are a single-color image data.

5. The remote conference system according to claim 1,
wherein the communication terminals further include an image replace unit configured to, when the function of the imaging unit is set to be disabled, replace the imaging data captured by the imaging unit with the alternative data, and
wherein the display control unit is configured to display the screen that includes the alternative data that have replaced the imaging data by the image replace unit and the imaging data that are captured by the other communication terminals.

6. The remote conference system according to claim 1, wherein the communication terminals further include an operating member configured to switch the imaging unit to be enabled and disabled.

7. A communication terminal that communicates with other communication terminals via a network, comprising:
an imaging unit;
a transmission unit configured to transmit first alternative data that differ from imaged data that are captured by the imaging unit to the other communication terminals when a function of the imaging unit is set to be disabled,
a receiving unit configured to, when a function of an imaging unit of one of the other communication terminals is set to be disabled in the one of the other communication terminals, receive second alternative data that differ from imaging data captured by the imaging unit from the one of the other communication terminals; and
a display control unit configured to display a screen including the second alternative data transmitted from the one of the other communication terminals on a display device.

8. (canceled)

9. The communication terminal according to claim 7,
wherein the display control unit is configured to display the screen that includes the second alternative data transmitted from the one of the other communication terminals and image data that are captured by a communication terminal other than the one of the other communication terminals that transmits the second alternative data among other of the communication terminals.

10. A communication terminal according to claim 7, wherein the first alternative data are image data having a data amount smaller than a data amount of the imaging data.

11. A non-transitory computer-readable medium storing a communication program that is executed in a communication terminal that communicates with other communication terminals via a network, causing the communication terminal to execute:
an imaging step of capturing imaging data by an imaging unit;
a transmission step of, when a function of the imaging unit is set to be disabled, transmitting first alternative data that differ from the imaging data to the other communication terminals,
a receiving step of, when a function of an imaging unit of one of the other communication terminals is set to be disabled in the one of the other communication terminals, receive second alternative data that differ from imaging data captured by the imaging unit from the one of the other communication terminals; and
a display control step of displaying a screen including the second alternative data transmitted from the one of the other communication terminals on a display device.

12. (canceled)
